(19) United States
(12) Patent Application Publication
(10) Pub. No.: US 2011/0055439 A1
(43) Pub. Date: Mar. 3, 2011

(54) BUS BRIDGE FROM PROCESSOR LOCAL BUS TO ADVANCED EXTENSIBLE INTERFACE

(75) Inventors: Liang Chen, Shanghai (CN); Wang Hongwei, Beijing (CN); Yong Lu, Shanghai (CN); Hao Yang, Shanghai (CN)

(73) Assignee: INTERNATIONAL BUSINESS MACHINES CORPORATION, Armonk, NY (US)

(21) Appl. No.: 12/825,624

(22) Filed: Jun. 29, 2010

(30) Foreign Application Priority Data
Aug. 31, 2009 (CN) 200910171388.0

(51) Int. Cl. G06F 5/14

(52) U.S. Cl. 710/57

(57) ABSTRACT

Disclosed is a method of processing a read/write request conforming to the PLB bus protocol and a bus bridge from PLB bus to AXI bus, the method comprising: receiving the read/write request conforming to the PLB bus protocol without waiting for an acknowledgement of successful execution of a previous read/write request conforming to the PLB bus protocol; buffering the read/write request conforming to the PLB bus protocol; mapping the buffered read/write request conforming to the PLB bus protocol to a read/write request conforming to a AXI bus protocol; and outputting the mapped read/write request conforming to the AXI bus protocol. The method and the bus bridge enable IP modules conforming to PLB bus protocol and AXI bus protocol to communicate and perform transaction mapping during communication, to guarantee that all the transactions are performed in an order desired by the PLB device, and improve communication efficiency of the SoC.

### FIELD OF DISCLOSURE

The present invention generally relates to a data processing method and system, and more specifically to a bus bridge from Processor Local Bus (PLB) of a System-on-a-chip (SoC) to Advanced Extensible Interface (AXI) and an associated mapping.

### SUMMARY

As the rapid development of the semiconductor process technology, System-on-a-chip (SoC) has increasingly become a mainstream development trend in the integrated circuit design. SoC refers to a technology in which a complete system is integrated on a single chip and all or partial necessary electronic circuits are packaged thereon. The so-called complete system generally includes a Central Processing Unit (CPU), a memory, a peripheral circuit and so on. SoC can provide an enhanced clock frequency, thereby reducing the power consumption of the chip. SoC is often used in miniature and increasingly complicated consumer electronic equipments. For example, a SoC of sound detection equipment provides, on a single chip, devices such as an audio receiver, analog-to-digital converter (ADC), microprocessor, necessary memories, and input/output logics.

SoC chip needs to integrate a complicated system and thus has a more complicated structure. Obviously, considerable human power and material resources will be spent if the chip design is completed from the beginning. Moreover, nowadays, the lifespan of electronic products are increasingly reduced, which requires the chip design to be completed in a shorter period. In order to accelerate the speed of SoC chip design, integrated circuit designers invoke in the SoC chip design existing IC circuits in the form of modules, to thereby simplify the chip design, shorten the design period and improve the design efficiency. IC modules that can be reused are called IP modules (or system macro cells, IP cores, chip cores, virtual devices, etc.). An IP module is a shortened form of an IC core with intellectual property, and has a function of integrating a group of circuit designs with intellectual property together to constitute basic units of the chip for use in building blocks in design. The IP module is designed in advance, is verified and has a certain determined function.

Processor Local Bus (PLB) and Advanced Extensible Interface (AXI) are popular communication architectures of the SoC, and interfaces of many IP modules are compatible with PLB or AXI. PLB bus is a high performance on-chip bus applied to a highly integrated Core+ASIC system and has a 64-bit address bus and a 128-bit data bus. PLB bus provides a standard interface between a processor core and an integrated bus controller, such that designers can develop a processor core library and a bus controller for the design of Core+ASIC and SoC system. PLB bus supports read/write data transmission between devices compatible with PLB bus interfaces.

AXI is a bus protocol which is a most important part of Advanced Microcontroller Bus Architecture (AMBA) 3.0 protocol proposed by ARM Corporation, and is a high performance, high bandwidth and low delay on-chip bus. The address/control and data transmission phases of AXI are separated from each other and use byte strobe to support unaligned data transmission, required for providing the first address for burst transmission. Separate read/write data channels of the AXI bus effectively support low-cost direct memory access operations, enable simultaneous emission of a plurality of addresses, support out-of-order transmission, and can add registers to provide timing convergence.

In order to seamlessly integrate different IP modules, the application is required to introduce the concept of bus bridge. Bus bridge enables IP modules supporting different buses to communicate with each other.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

The above and other objects, features and advantages of the invention become more apparent through the more detailed descriptions of the exemplary embodiments of the invention in the drawings, wherein the same reference signs generally represent the same components in the exemplary embodiments of the invention.

FIG. 1 shows a communicating relationship between the PLB to AXI bus bridge of the invention and a PLB device and an AXI device;

FIG. 2 is a block diagram showing the structure of a PLB to AXI bus bridge;

FIG. 3 schematically shows embodiments of a write address register file and a collision detector embedded in the PLB to AXI bus bridge;

FIG. 4 shows a main flow of the method of processing a read/write request conforming to the PLB bus protocol;

FIG. 5 shows an particular embodiment of the method of FIG. 4; and

FIG. 6 gives an example of a read/write transaction sequence processed by the PLB to AXI bus bridge.

### DETAILED DESCRIPTION

In order to integrate the IP modules supported by PLB and AXI, the application requires a PLB to AXI bus bridge and a mapping method thereof. According to one aspect of the invention, a method of processing a read/write request conforming to a PLB bus protocol is disclosed, the method comprising the steps of: receiving the read/write request conforming to the PLB bus protocol without waiting for an acknowledgement of successful execution of a previous read/write request conforming to the PLB bus protocol; buffering the read/write request conforming to the PLB bus protocol; mapping the buffered read/write request conforming to the PLB bus protocol to a read/write request conforming to a AXI bus protocol; and outputting the mapped read/write request conforming to the AXI bus protocol.

According to another aspect of the invention, a bus bridge between a PLB bus and an AXI bus is disclosed, the bus bridge comprising: a PLB device interface module arranged to receive a read/write request conforming to a PLB bus protocol without waiting for an acknowledgement of successful execution of a previous read/write request conforming to the PLB bus protocol; a buffer arranged to buffer the read/write request conforming to the PLB bus protocol; a mapping module arranged to map the buffered read/write request conforming to the PLB bus protocol to a read/write request conforming to an AXI bus protocol; and an AXI device interface module arranged to output the mapped read/write request conforming to the AXI bus protocol.

The processing method and the bus bridge enable the IP modules which conform to the PLB bus protocol and the AXI bus protocol to communicate with each other, perform transaction mapping during communication, guarantee that all transactions are performed in an order desired by the PLB devices, and improve communication efficiency of the SoC.

Preferred embodiments of the invention will be described in detail by referencing to the drawings where preferred embodiments of the invention are shown. However, the invention can be carried out in various forms and shall not be understood as being restricted by the embodiments set forth here. On the contrary, the embodiments are provided here for making the invention more thorough and comprehensive and conveying the scope of the invention completely to those skilled in the art.

The bus bridge of the invention can be used to transmit a read/write request of a PLB device to an AXI device, such that IP modules compatible with the PLB and IP modules compatible with the AXI on the SoC are integrated seamlessly.

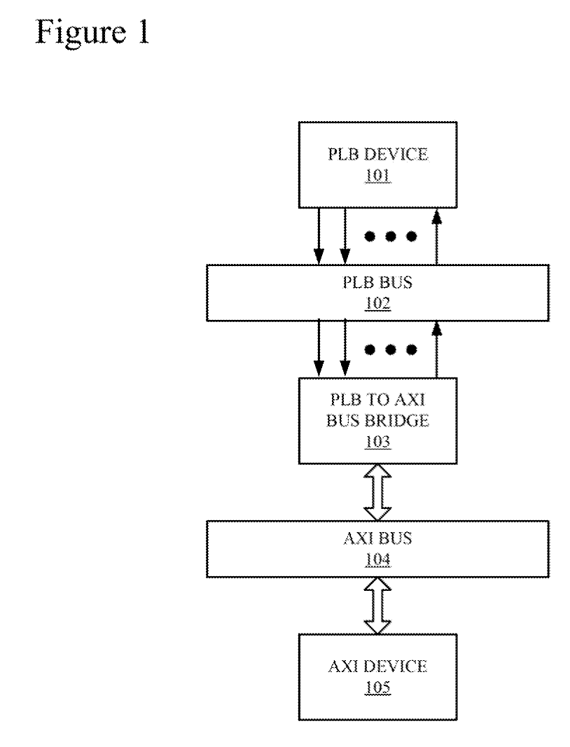

FIG. 1 shows the communicating relationship between a PLB to AXI bus bridge 103 of the invention and a PLB device 101 and an AXI device 105. According to FIG. 1, PLB device 101 sends a read/write request to PLB to AXI bus bridge 103 via a PLB bus 102, PLB to AXI bus bridge 103 maps the received read/write request conforming to PLB bus 102 protocol to a read/write request conforming to a AXI bus 104 protocol, and outputs the mapped read/write request conforming to AXI bus 104 protocol to AXI device 105 via AXI bus 104. PLB to AXI bus bridge 103 of the invention adopts the way of Buffered write, specifically, PLB device 101 sends the read/write request. PLB to AXI bus bridge 103 receives the read/write request conforming to PLB bus 102 protocol and buffers the received read/write request, performs mapping, outputs the mapped read/write request conforming to AXI bus 104 protocol to AXI device 105, receives an acknowledgement of the end of the processing of the read/write request of AXI device 105, and returns the acknowledgement to PLB device 101. This bus bridge of buffered write can keep the order of all transactions and can issue a next read/write request without waiting for an acknowledgement of successful execution of the issued read/write request, while in contrary to non-buffered write, the next read/write request can not be issued until the successful execution of the issued read/write request is acknowledged. The bus bridge of the invention therefore has a high throughput and a good performance.

PLB bus 102 only supports in order transfer, and AXI bus 104 supports both in order transfer and out-of-order transfer. For this reason, when the read/write request issued by PLB device 101 goes to AXI device 105 through bus bridge 103, bus bridge 103 can be either in order transfer or out-of-order transfer.

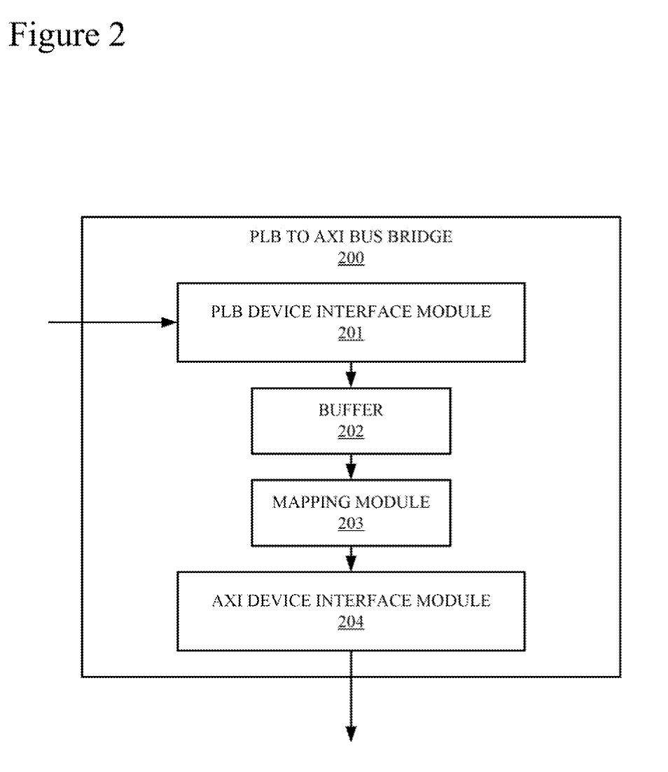

FIG. 2 is a block diagram showing the structure of a PLB to AXI bus bridge 200. According to FIG. 2, PLB to AXI bus bridge 200 comprises a PLB device interface module 201 arranged to receive a read/write request conforming to the PLB bus protocol without waiting for an acknowledgement of successful execution of a previous read/write request conforming to the PLB bus protocol; a buffer 202 arranged to buffer the read/write request conforming to the PLB bus protocol, the read/write request conforming to the PLB bus protocol being buffered using a FIFO (First-In First-Out) memory in an embodiment and those skilled in the art knowing that other buffering modes, e.g. stack, can be adopted; a mapping module 203 arranged to mapping the buffered read/write request conforming to the PLB bus protocol, to a read/write requests conforming to the AXI bus protocol; and a AXI device interface module 204 arranged to output the mapped read/write request conforming to the AXI bus protocol. PLB device interface module 201 receives the read/write request from the PLB device through the PLB bus, and addresses, control signals and data on the PLB bus are sent respectively through different buses, e.g. address buses, write data buses and read data buses; The AXI device interface module 204 outputs the mapped read/write request conforming to the AXI bus protocol to the AXI device through the AXI bus, and similarly, addresses, control signals and data on the AXI bus are sent respectively through different channels, e.g. address channels, signal channels and data channels. Although in the art, the control signals and data of the PLB bus and the AXI bus are sent through different channels, the control signals and data called the PLB bus are sent respectively through different Buses, and the control signals and data called the AXI bus are sent respectively through different channels.

In mapping module 203, with respect to the PLB write request, the bus bridge from PLB bus to AXI bus firstly converts the control signals (e.g., signals representing the type and size of the transmission) of the PLB write request into AXI write transfer control signals and sends them to an AXI write address channel together with the received PLB write addresses; sends write data coming form the PLB bus to an AXI write data channel; and converts signals from an AXI write response channel to control signals conforming to the PLB protocol and transfers them to a PLB related device through the PLB bus. With respect to the PLB read request, mapping module 203 of the bus bridge from PLB bus to AXI bus firstly converts the control signals (e.g., signals representing the type and size of the transmission) of the PLB read request into AXI read transfer control signals and sends them through an AXI read address channel together with the received PLB read addresses; after receiving read data and read response from an AXI read data channel, the bus bridge from PLB bus to AXI bus is responsible for converting the read data and read responses into read data and signals conforming to the PLB protocol according to the requirements of the PLB protocol, and transfers them to the PLB related device through the PLB bus. The bus bridge from PLB bus to AXI bus using the buffered write may result in read/write collisions, that is, a read/write collision occurs if an uncompleted write operation is carried out at an address to be read by the read request, and the execution of the read operation that collides with the write operation shall be paused.

In one embodiment, buffer 202 buffers the received read/write request using a FIFO memory. Specifically, buffer 202 may comprise a Write Request FIFO memory (WR FIFO) and a Read Request FIFO memory (RR FIFO). In addition, with regard to the data operation, buffer 202 preferably further comprises a Write Data FIFO memory (WD FIFO) and a Read Data FIFO memory (RD FIFO). Preferably, the PLB to AXI bus bridge further comprises a buffer controller arranged to control data buffering of buffer 202, and one of the functions of the buffer controller is: judging whether buffer 202 is full or not; if the buffer is full, waiting until buffer 202 has free spaces to buffer the read/write request; and if buffer 202 isn't full, buffering the received read/write request by buffer 202. The buffer controller can control the WR FIFO memory, the RR FIFO memory, or even the WD FIFO memory and the RD FIFO memory. Specifically, if a write request is received, the buffer controller judges whether the WR FIFO memory is full or not; if it is full, the buffer controller waits until the WR FIFO memory has free spaces to perform the buffering operation; if write data is received, the buffer controller judges whether the space of the WD FIFO memory is full or not, and needs waiting if it is full. In practice, the write request and the write data get ready simultaneously, and the write data is received as soon as the acknowledgement of successful execution of the write request is received. In addition, the WD FIFO memory may have a space large enough so as to support a maximum PLB write burst transfer. All PLB write transactions are processed as buffered write, that is, if the WD FIFO memory of the PLB to AXI bus bridge has free spaces, the acknowledgement of the write data can be returned back to the PLB device directly, thus the write data can be received immediately. If what is received is a read request, it is judged that whether the RR FIFO memory is full or not, and waiting is needed if it is full; otherwise, the buffer can buffer the read request.

In one embodiment, PLB to AXI bus bridge 200 further comprises a decider, a write address register file (WARF) and a write address controller. The decider is arranged to judge whether the received read/write request conforming to the PLB bus protocol is a write request or a read request. If the received read/write request conforming to the PLB bus protocol is a write request, the WARF stores a start address and an end address of the write request. The storing of the start address and the end address of the write request by the WARF and the buffering of the read/write request conforming to the PLB bus protocol by the buffer can be done simultaneously or successively. The writing of the start address and the end address is obtained on the basis of the type and size of the transmission of the write request and can be saved as an item in the WARF. Each item has a label for indicating whether the item is valid or not currently. The write address controller can be used to control the label of the item to indicate whether it is valid or not. The write address controller updates the label of the corresponding item when the acknowledgement of successful execution of the AXI write returns, to indicate that the corresponding write start address and end address are invalid; In another embodiment, the write start address and end address in the WARF may not be labeled either, and only the valid write start address and end address are held in the WARF, and the stored start address and end address of the write request are deleted if an acknowledgement of successful execution of the write request is received. The above can be used in the AXI device of in order transfer.

For the AXI device of out-of-order transfer, if the received read/write request conforming to the PLB bus protocol is a write request, PLB to AXI bus bridge 200 can label that write request, and store the label of the write request together with the start address and end address of the valid write request at the WARF; and the write request conforming to the AXI bus protocol to be outputted contains the label of that write request.

The main purpose of the valid write start address and end address stored in WARF is to prevent read operation from colliding. Since the write request and the read request both are buffered by the buffer in the operations of the bus bridge, if the execution of the previous write operation isn't completed and the subsequent read operation has been performed, a collision may occur and this causes incorrect readout data. When the PLB read request arrives, PLB to AXI 200 bus bridge makes a collision detection by comparing the read address with all valid items in the WARF. Therefore, in one embodiment, PLB to AXI bus bridge 200 further comprises a collision detector which obtains the start address and end address of the read request if the decider judges that the received read/write request conforming to the PLB bus protocol is a read request; and judges whether or not the start address and end address of the read request is within the scope of the stored start address and end address of the valid write request; if it is, then waits until the start address and end address of the read request isn't within the scope of the stored start address and end address of the valid write request. In this way, the read operation which collides with the valid write operation waits until the colliding write operation is finished, and then the read operation is executed, thus the read/write collision is resolved.

After a collision is resolved or if it is judged that no collision exists, mapping module 203 maps the buffered read request conforming to the PLB bus protocol to a read request conforming to the AXI bus protocol. AXI device interface module 204 outputs the mapped read/write request conforming to the AXI bus protocol. AXI device interface module 204 outputs the mapped read/write request conforming to the AXI bus protocol to the AXI devices through the AXI bus protocol. The AXI device will return an acknowledgement after it completes the read/write operation. For a read operation, the AXI bus will put the readout data in a data channel, buffer it to the RD FIFO memory through the data channel of AXI device interface module 204, and transfer it to the PLB bus through the data channel of PLB device interface module 201; and an acknowledgement information of successful execution of the reading is also transferred to the PLB device through a signal channel of the same path. In addition, a signal indicative of successful execution of the write request is also transferred to the PLB device through the signal channel of the path.

In one embodiment, the AXI device interface module of the PLB to AXI bus bridge receives from the AXI device an acknowledgement of successful execution of the valid write request, so it can update the start address and end address of the valid write request stored in the WARF to be invalid according to the label of the write request. In this way, a quick update is allowed and a probability of the occurrence of read/write collisions is lower; moreover, since the PLB device interface module outputs the acknowledgement of successful execution of the successfully executed write request according to the label of the write request, thus the out-of-order transfer of the AXE device can be restored to the in order transfer required by the PLB device in the bus bridge.

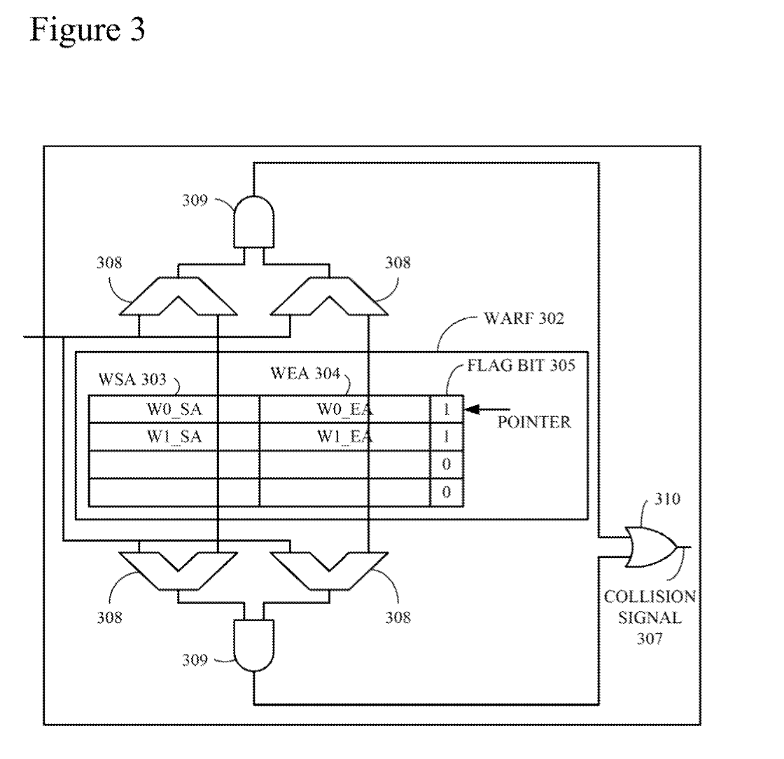

FIG. 3 schematically shows embodiments of WARF 302 and collision detector embedded in the bus bridge from PLB bus to AXI bus. According to FIG. 3, the WARF includes N items, and the collision detector includes 2N comparators 308, N AND gates 309 and one OR gate 310. A collision occurs if the read address is not less than the write start address (WSA) 303 and is not more than the write end address (WEA) 304, and the read address is compared with all the items whose flag bit 305 is equal ‘1’ and the comparison result is outputted through a collision signal 307 generated by the OR gate 310.

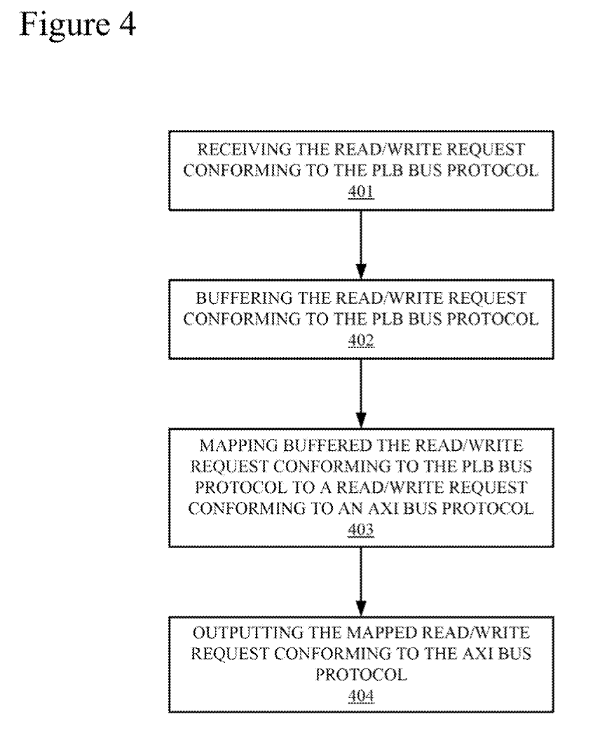

Under the same inventive concept, the invention further discloses a method of processing a read/write request conforming to the PLB bus protocol. FIG. 4 shows a main flow of the method comprising: a block 401 of receiving a read/write request conforming to the PLB bus protocol without waiting for an acknowledgement of successful execution of a previous read/write request conforming to the PLB bus protocol; a block 402 of buffering the read/write request conforming to the PLB bus protocol; a block 403 of mapping the read/write request conforming to the PLB bus protocol to a read/write request conforming to the AXI bus protocol; and a block 404 of outputting the mapped read/write request conforming to the AXI bus protocol. The execution of the read operation which is colliding with the write operation needs to be paused in the method.

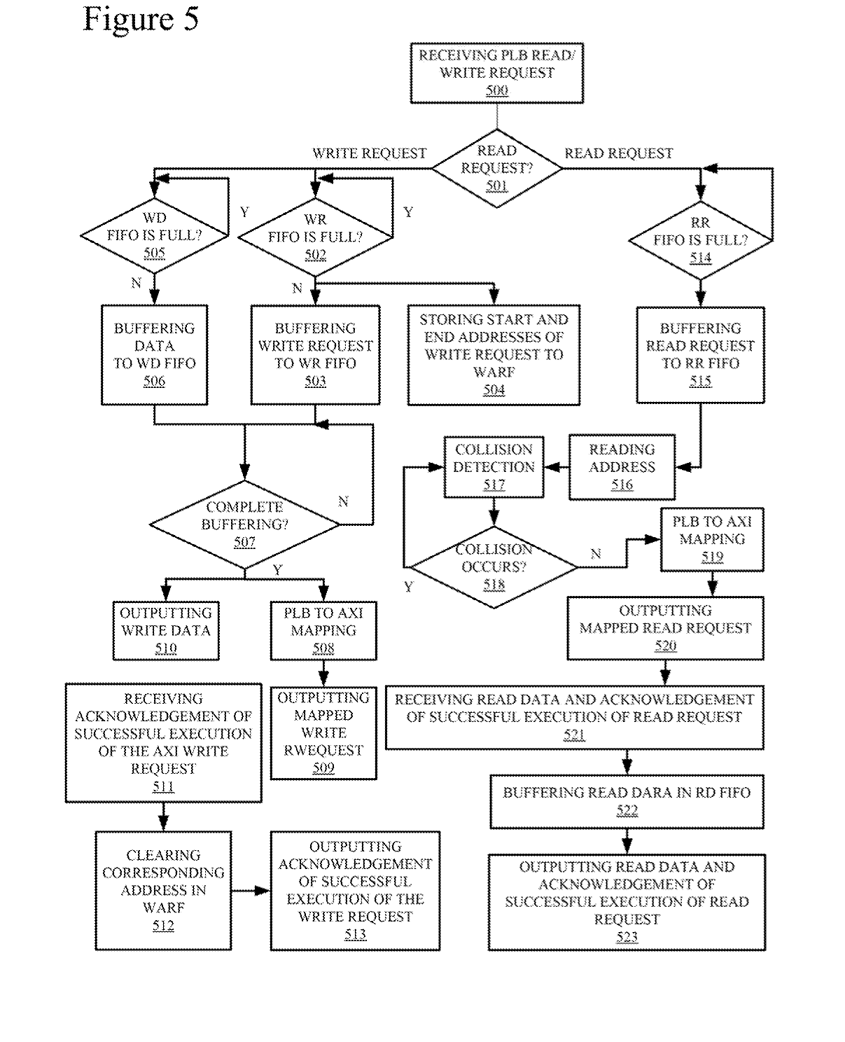

FIG. 5 shows an embodiment of the method of FIG. 4, comprising: a block 500 of receiving the read/write request conforming to the PLB bus protocol without waiting for an acknowledgement of successful execution of a previous read/write request conforming to the PLB bus protocol; a block 501 of judging whether the received read/write request conforming to the PLB bus protocol is a read request or a write request; if it is a write request, since the write request includes a write address, a write data and a control signal, buffering the write address and the control signal by the WR FIFO memory and buffering the write data by the WD FIFO memory; a block 502 of judging whether the WD FIFO memory for buffering the write request conforming to the PLB bus protocol is full or not; if it is full, then waiting until the memory has free spaces to buffer the write request; otherwise, a block 503 of buffering the write request conforming to the PLB bus protocol; and a block 504 before or after the block 503, of storing the start address and end address of the write request as the start address and end address of a valid write request. One embodiment of the valid start address and end address uses a flag bit, wherein the flag bit is set to a special value, e.g. 1, to show that the start address and end address are valid addresses, and the flag bit is set to another value, e.g. 0, to show that the start address and end address are invalid addresses. Another embodiment does not use a flag bit, wherein, if the start address and end address are stored, they are valid start address and end address; otherwise they will be deleted.

The method according to FIG. 5 further comprises: a block 505 of judging whether the WD FIFO memory to buffer the write data conforming to the PLB bus protocol is full or not while buffering the write address and the control signal, and if it is full, waiting until the memory has free spaces to buffer the write data, and if it is not full, then buffering the write data in block 506. Then in block 507, it is judged whether the write address, write data and control signal of the write request are buffered or not, and only if they are all buffered, the write request is illustrative to be completely received. Otherwise, if either of the WR FIFO and the WD FIFO does not buffer data or addresses etc. it waits until the write request is completely buffered. Then in block 508, the buffered write request conforming to the PLB bus protocol is mapped to a write request conforming to the AXI bus protocol; then in block 509, the mapped write request conforming to the AXI bus protocol is outputted. Simultaneously with the blocks 508 and 509, in block 510, the write data is outputted. Thus the write request conforming to the AXI bus protocol is outputted to the AXI device and then is executed; when an acknowledgment of successful execution of the write request from the AXI bus protocol is received in block 511, because the write request received in the step from the AXI bus protocol is possibly not the same write request with the write request issued in blocks 509 and 510 and may be an acknowledgement of successful execution of the previous write request, in FIG. 5, the block 511 is not linked to blocks 509 and 510. In block 512, the valid start address and end address are cleared or the flag bit is set to be invalid. Then in block 513, an acknowledgement of successful execution of the write request is outputted.

In other embodiments of the invention, if the received read/write request conforming to the PLB bus protocol is a write request, the method further comprises: labeling the write request; storing the label of the write request together with the start address and end address of the valid write request; wherein the outputted write request conforming to the AXI bus protocol contains the label of the write request. Thus, if an acknowledgement of successful execution of the valid write request is received, the acknowledgement contains the label of the write request, and the stored start address and end address of the valid write request can be updated to be invalid according to the label of the write request, so the speed of updating is accelerated and read/write collisions can be avoided more effectively. Then the acknowledgement of successful execution of the successfully executed write request is outputted according to the label of the write request, and the out-of-order transfer of the AXI device can be restored to the in order transfer required by the PLB device.

If in the block 501, it is judged that the received read/write request conforming to the PLB bus protocol is a read request, firstly in block 514, it is judged whether the RR FIFO memory to buffer the read request conforming to the PLB bus protocol is full or not, wherein the RR FIFO is used to buffer the read address and control signal of the read request; if it is full, waiting until the memory has free spaces to buffer the read request. If it isn't full, then in block 515, buffering the read request conforming to the PLB bus protocol, and in block 516, gaining the read address of the read request, and executing collision detection in block 517, i.e. judging whether the start address and end address of the read request is within the scope of the stored start address and end address of the valid write request or not; At block 518, judging a result of the collision detection. If there is a collision, waiting and judging repeatedly until the start address and end address of the read request aren't within the scope of the stored start address and end address of the valid write request. If there is not a collision, then in block 519, mapping the buffered read request conforming to the PLB bus protocol to a read request conforming to the AXI bus; then in block 520, outputting the mapped read request conforming to the AXI bus. The read request conforming to the AXI bus is outputted to the AXI device and then is executed; when an acknowledgement of successful execution of the read request from the AXI bus and the outputted data are received in block 521, because the read request received in the step from the AXI bus protocol is possibly not the same with the read request issued in the block 520 and it may be an acknowledgement of successful execution of the previous read request, the block 521 isn't linked to the block 520. In block 522, buffering the read-out data; and then in block 523, outputting the read-out data and the acknowledgement of successful execution of the read request.

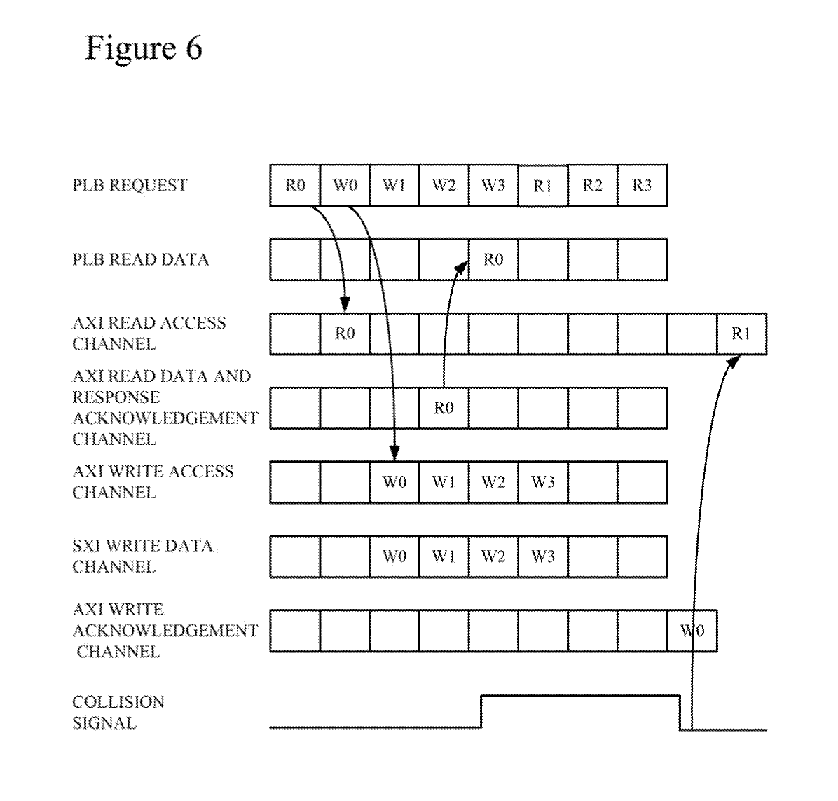

FIG. 6 gives an example of read/write transaction sequences processed by the PLB to AXI bus bridge. Here, the PLB sends write requests in a steaming mode (a PLB transfer is divided to an address stage and a data stage, and if the address stage transferred currently is temporally overlapped with data stage of the last transfer, then the transfer is steaming), and a depth of the streaming write or read operation is 4 (that is, there are 4 write or read operations that are simultaneously performed in a steaming mode). Those skilled in the art know that, the steaming mode is merely an implementation and may be otherwise not adopted. The PLB to AXI bus bridge receives R0, W0, W1, W2, W3, R1, R2 and R3 requests in order. When R0 is received, a collision detection is carried out, and if no collision is found, the PLB to AXI bus bridge processes the R0 read request; when W0, W1, W2, W3 are received, the PLB to AXI bus bridge stores the write operation address into the WARF while processing the write operation; when R1 is received the collision detection is carried out and a collision between W0 and R1 is found; when an acknowledgement of successful execution of the W0 write request is returned, the collision is removed and the PLB to AXI bus bridge processes the R1 read request. By means of collision detection, all the PLB write data can adopt the way of buffered write, a collision of read after write is avoided, and communication performance is improved.

Although the exemplary embodiments of the invention are described herein with reference to the drawings, it should be understood that the invention is not limited to these precise embodiments, and various variations and modifications can be made to the embodiments by those skilled in the art without departing from the scope and spirit of the invention. All these variations and modifications are intended to be contained in the scope of the invention defined in appended claims.

Those skilled in the art could know from the above description that, the invention can be embodied as devices, methods or computer program products. Therefore, the invent can be implemented in the following forms: complete hardware, complete software (including firmware, resident software, microcode etc.), or a combination of software parts and hardware parts generally called “circuit”, “module” or “system” in this text. Moreover, the invention can also adopt the form of computer program products embodied in any tangible medium of expression, the medium comprising computer usable program codes.

Any combinations of one or more computer usable or computer readable medium can be used. The computer usable or computer readable medium may be but not limited to, for example, electrical, magnetic, optical, electromagnetic, infrared, or semiconductor systems, devices, appliances or propagation medium. Specific examples of the computer readable medium (a non-exhaustive list) comprise: electrical connection with one or more conductors, portable computer disk, hard disk, Random-Access Memory (RAM), Read-Only Memory (ROM), Erasable Programmable Read-Only Memory (EPROM or flash memory), optical fiber, portable Compact-Disk Read-Only-Memory (CD-ROM), optical memory device, transmission medium supporting such as Internet or intranet, or magnetic memory device. Note that the computer usable or computer readable medium even can be papers or other suitable medium on which programs are printed, this is because the programs can be obtained electronically by electrically scanning the papers or other medium, and then be compiled, interpreted or processed in an appropriate way, and be stored in a computer memory if necessary. In the context of this document, the computer usable or computer readable medium may be any medium which contains, stores, conveys, propagates or transmits programs which are to be used by an instruction executing system, device or appliance or are associated with the instruction executing system, device or appliance. The computer usable medium may include data signals which are contained in the baseband or propagated as a part of the carrier wave and are embodied as computer usable program codes. The computer usable program codes may be transmitted with any suitable medium including but not limited to radio, electrical wire, optical cable, RF and etc.

The computer program codes for executing the operation of the invention can be written with any combination of one or more programming languages, the programming languages including object-oriented programming languages such as Java, Smalltalk, C++, and conventional procedural programming languages such as “C” programming languages and similar programming languages. The program codes can be completely run on the user's computer, partly run on the user's computer, run as an independent software package, partly run on the user's computer and partly run on a remote computer, or completely run on a remote computer or server. In the last case, the remote computer can be connected to the user's computer through any kind of network including Local Area Network (LAN) or Wide Area Network (WAN), or can be connected to an external computer (for example, through the Internet using an Internet Service Provider).

Furthermore, each block in the flow charts and/or block diagrams of the invention and combinations of the blocks in the flow charts and/or block diagrams can be implemented using computer program instructions. These computer program instructions can be provided to processors of a general purpose computer, a special purpose computer or other programmable data processing devices so as to produce a machine which produces means for realizing the functions/operations specified in the blocks of the flow charts and/or block diagrams, through the instructions executed by the computer or the other programmable data processing devices.

The computer program instructions can be stored in a computer readable medium which can instruct the computer or other programmable data processing devices to operate in a specific manner, thus the instructions stored in the computer readable medium produce a product comprising instruction means for realizing the functions/operations specified in the blocks of the flow charts and/or block diagrams.

The computer program instructions can also be loaded into the computer or other programmable data processing devices, thus a series of operation steps are executed on the computer or other programmable data processing devices, so as to produce a computer-implemented process, thereby the instructions executed on the computer or other programmable devices provide a process of realizing the functions/operations specified in the blocks of the flow charts and/or block diagrams.

We claim:

1. A method of processing a read/write request conforming to a PLB bus protocol comprising:
receiving the read/write request conforming to the PLB bus protocol without waiting for an acknowledgement of successful execution of a previous read/write request conforming to the PLB bus protocol;
buffering the read/write request conforming to the PLB bus protocol;
mapping the buffered read/write request conforming to the PLB bus protocol to a read/write request conforming to a AXI bus protocol; and
outputting the mapped read/write request conforming to the AXI bus protocol.

2. The method of claim 1, wherein buffering the read/write request conforming to the PLB bus protocol further comprising:
judging whether a buffer for buffering the read/write request conforming to the PLB bus protocol is full or not; and
if the buffer is full, waiting until the buffer has free spaces to buffer the read/write request.

3. The method of claim 1, wherein mapping the buffered read/write request conforming to the PLB bus protocol to a read/write request conforming to a AXI bus protocol further comprising:
judging whether the received read/write request conforming to the PLB bus protocol is a read request or a write request; and
if the received read/write request conforming to the PLB bus protocol is a write request, storing a start address and end address of the write request as a start address and end address of a valid write request.

4. The method of claim 3, wherein after outputting the mapped read/write request conforming to the AXI bus protocol, further comprising:
if an acknowledgement of successful execution of the valid write request is received, updating the stored start address and end address of the valid write request to be invalid; and
outputting the acknowledgement of successful execution of the write request.

5. The method of claim 3, wherein if the received read/write request conforming to the PLB bus protocol is a write request, the method further comprising:
labeling the write request; and
storing the label of the write request together with the start address and end address of the valid write request;
wherein the outputted write request conforming to the AXI bus protocol contains the label of the write request.

6. The method of claim 5, wherein after outputting the mapped read/write request conforming to the AXI bus protocol, further comprising:
if the acknowledgement of successful execution of the valid write request is received, updating the stored start address and end address of the valid write request to be invalid according to the label of the write request; and
outputting the acknowledgement of successful execution of the successfully executed write request according to the label of the write request.

7. The method of claim 3, wherein if the received read/write request conforming to the PLB bus protocol is a read request, the method further comprising:
obtaining a start address and end address of the read request;
judging whether the start address and end address of the read request is within a scope of the stored start address and end address of the valid write request or not; and
if it is, repeatedly judging until the start address and end address of the read request is not within a scope of the stored start address and end address of the valid write request.

8. The method of claim 7, wherein after outputting the mapped read request conforming to the AXI bus protocol, further comprising:
if data that is read out by the outputted read request conforming to the AXI bus protocol and the acknowledgement of successful execution of the read request are received,
buffering the read-out data; and
outputting the read-out data and the acknowledgement of successful execution of the read request.

9. A bus bridge between a PLB bus and an AXI bus comprising:
a PLB device interface module arranged to receive a read/write request conforming to a PLB bus protocol without waiting for an acknowledgement of successful execution of a previous read/write request conforming to the PLB bus protocol;
a buffer arranged to buffer the read/write request conforming to the PLB bus protocol;
a mapping module arranged to map the buffered read/write request conforming to the PLB bus protocol to a read/write request conforming to an AXI bus protocol; and
an AXI device interface module arranged to output the mapped read/write request conforming to the AXI bus protocol.

10. The bus bridge of claim 9, further comprising a buffer controller arranged to:
judge whether a buffer for buffering the read/write request conforming to the PLB bus protocol is full or not; and
if the buffer is full, wait until the buffer has free spaces to buffer the read/write request.

11. The bus bridge of claim 9, wherein the bus bridge further comprising:
a decider for judging whether the received read/write request conforming to the PLB bus protocol is a read request or a write request; and
a write address register file for, if the decider judges that the received read/write request conforming to the PLB bus protocol is a write request, storing a start address and end address of the write request as a start address and end address of a valid write request.

12. The bus bridge of claim 11, wherein if the AXI device interface module receives an acknowledgement of successful execution of one write request,
the write address register file updates the stored start address and end address of the valid write request to be invalid; and
the PLB device interface module outputs the acknowledgement of successful execution of the write request.

13. The bus bridge of claim 11, wherein if the decider judges that the received read/write request conforming to the PLB bus protocol is a write request,
the bus bridge labels the write request, and
the write address register file stores the label of the write request together with the start address and end address of the valid write request,
wherein the outputted write request conforming to the AXI bus protocol contains the label of the write request.

14. The bus bridge of claim 13, wherein if the AXI device interface module receives the acknowledgement of successful execution of the valid write request,
the write address register file updates the stored start address and end address of the valid write request to be invalid according to the label of the write request; and
the PLB device interface module outputs the acknowledgement of successful execution of the successfully executed write request according to the label of the write request.

15. The bus bridge of claim 11, further comprising a collision detector arranged to:
if the decider judges that the received read/write request conforming to the PLB bus protocol is a read request, after the buffer buffers the read request conforming to the PLB bus protocol, obtain a start address and end address of the read request;
judge whether the start address and end address of the read request is within a scope of the stored start address and end address of the valid write request or not; and
if it is, repeatedly judge until the start address and end address of the read request is not within a scope of the stored start address and end address of the valid write request.

16. The bus bridge of claim 15, wherein
the AXI device interface module is further arranged to receive data that is read out by the read request conforming to the AXI bus protocol outputted by the AXI device interface module, and the acknowledgement of successful execution of the read request,
the buffer is further arranged to buffer the read-out data; and
the PLB device interface module is further arranged to output the read-out data and the acknowledgement of successful execution of the read request.
